(19) United States
(12) Patent Application Publication
(10) Pub. No.: US 2018/0150810 A1
(43) Pub. Date: May 31, 2018

(54) CONTEXTUAL AUGMENTED REALITY OVERLAYS

(71) Applicant: BANK OF AMERICA CORPORATION, CHARLOTTE, NC (US)

(72) Inventors: JISOO LEE, CHESTERFIELD, NJ (US); GRAHAM M. WYLLIE, CHARLOTTE, NC (US); VICTORIA L. DRAVNEEK, CHARLOTTE, NC (US); JOSEPH N. JOHANSEN, ROCK HILL, SC (US); ELIZABETH S. VOTAW, POTOMAC, MD (US)

(21) Appl. No.: 15/363,388

(22) Filed: Nov. 29, 2016

(51) Int. Cl. G06Q 20/10; H04N 5/232; G06K 9/00; G06T 11/60; H04L 29/06

(52) U.S. Cl. CPC G06Q 20/102; H04N 5/23293; G06K 9/00442; G06T 11/60; H04L 2209/56; G06K 2209/01; G06T 2207/20221; G06T 2207/30176; H04L 63/0428

(57) ABSTRACT

An augmented reality system that includes an augmented reality user device for a user that includes a display that overlays virtual objects onto tangible objects in real-time and a camera that captures images of a document. The augmented reality user device further includes one or more processors implementing an optical character recognition (OCR) engine, an electronic transfer engine, and a virtual overlay engine. The OCR engine obtains text information from the image of the document. The electronic transfer engine generates a document token that includes the text information from the document and a user identifier that identifies a user, sends the document token to a remote server, and receives virtual overlay data from the server. The virtual overlay data includes a status tag that indicates the current status of the document. The virtual overlay engine presents the status tag as a virtual object overlaid onto the document.

### TECHNICAL FIELD

The present disclosure relates generally to performing operations using an augmented reality display device that overlays graphic objects with objects in a real scene.

### BACKGROUND

When a person receives a document, for example in the mail, they may want to find information related to the document and/or to determine whether there are any actions that need to be taken for the document. The information the person is looking for may be distributed within multiple sources and databases. Using existing systems, when a person is looking for information located among different databases with different sources, the person has to make individual data requests to each of the different sources in order to obtain the desired information. The process of making multiple data requests to different data sources requires a significant amount of processing resources to generate the data requests. Typically processing resources are limited and the system is unable to perform other tasks when processing resources are occupied which degrades the performance of the system.

The process of sending multiple data requests and receiving information from multiple sources occupies network resources until all of the information has been collected. This process poses a burden on the network which degrades the performance of the network. Thus, it is desirable to provide the ability to securely and efficiently request information from multiple data sources.

### SUMMARY

In one embodiment, the disclosure includes an augmented reality system with an augmented reality user device for a user. The augmented reality user device has a display that overlays virtual objects onto tangible objects in real-time. The augmented reality user device also has a camera that captures images of a physical document. The augmented reality user device further includes one or more processors connected to the display and the camera.

The processors implement an optical character recognition (OCR) engine, an electronic transfer engine, and a virtual overlay engine. The optical character recognition engine obtains text information from an image of the physical document. The electronic transfer engine generates a document token that includes the text information from the document and a user identifier that identifies a user. The electronic transfer engine encrypts the document token and sends the document token to a remote server and receives virtual overlay data from the server in response to sending the document token. The virtual overlay data includes a status tag that indicates the current status of the physical document. The virtual overlay engine presents the status tag as a virtual object overlaid onto the physical document.

The augmented reality system further includes a remote server with a transfer management engine that receives and decrypts the document token. The transfer management engine obtains payment history for the user based on the document token and determines whether the physical document has been paid based on the payment history. The transfer management engine generates virtual overlay data that comprises the status tag identifying the physical document as paid in response to determining that the physical document has been paid. The transfer management engine generates virtual overlay data that comprises the status tag identifying the physical document as not paid in response to determining that the physical document has not been paid. The transfer management engine then sends the virtual overlay data to the augmented reality user device.

The present embodiment presents several technical advantages. In one embodiment, an augmented reality user device allows a user to make a reduced number of data requests to obtain information from multiple data sources.

Additionally, the augmented reality user device allows the user to authenticate themselves which allows the user to request and obtain information that is specific to the user without having to provide different credentials to authenticate the user with each data source.

The amount of processing resources used by the reduced number of data requests is significantly less than the amount of processing resources used by existing systems. The overall performance of the system is improved as a result of consuming less processing resources. Using a reduced number of data requests also reduces the amount of data traffic required to obtain information from multiple sources which results in improved network utilization and network performance.

The augmented reality user device generates document tokens based on an text information from a document and the identify of a user which improves the performance of the augmented reality user device by reducing the amount of information required to identify a document and a user and to request information linked with the document and the user. Document tokens are encoded or encrypted to obfuscate and mask information being communicated across a network. Masking the information being communicated protects users and their information in the event of unauthorized access to the network and/or data occurs.

The augmented reality user device uses optical character recognition to capture text information from images of a document. Retrieving the text information from an image of the document allows the augmented reality user device to reduce the amount of time required to make a data request compared to existing systems that rely on the user to manually enter all of the information for a request. Using optical character recognition to capture information for the data request also reduces the likelihood of user input errors and improves the reliability of the system.

Another technical advantage is the augmented reality user device allows a user to view information about a document as a virtual or graphic object overlaid onto the document. This allows the user to quickly view information for multiple documents that are in front of the user.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a augmented reality system configured to overlay virtual objects with a real scene;

FIG. 2 is a first person view of an embodiment for an augmented reality user device overlaying virtual objects with a real scene;

FIG. 3 is a first person view of another embodiment for an augmented reality user device overlaying virtual objects with a real scene;

FIG. 4 is a schematic diagram of an embodiment of an augmented reality user device employed by the augmented reality system;

FIG. 5 is a flowchart of an embodiment of an augmented reality overlaying method; and

FIG. 6 is a flowchart of another embodiment of an augmented reality overlaying method.

### DETAILED DESCRIPTION

When a person is reviewing a physical document, the person may need different kinds of information from multiple sources in order to make a decision about how to deal with the document. For example, the person may want to look-up information about the document, their personal information, and their previous actions or history with the document. All of this information may be located in different databases with different sources which results in several technical problems.

Using existing systems, the person has to make individual data requests to each of the different sources in order to obtain the desired information. The process of making multiple data requests to different data sources requires a significant amount of processing resources to generate the data requests. Typically processing resources are limited and the system is unable to perform other tasks when processing resources are occupied which degrades the performance of the system. The process of sending multiple data requests and receiving information from multiple sources occupies network resources until all of the information has been collected. This process poses a burden on the network which degrades the performance of the network.

Additionally, each data request may require different credentials to authenticate the person with each of the different sources. Providing different credentials to each source increases the complexity of the system and increases the amount of data that is sent across the network. The increased complexity of the system makes existing systems difficult to manage. The additional data that is sent across the network both occupies additional network resources and exposes additional sensitive information to network.

A technical solution to these technical problems is an augmented reality user device that allows a user to make a reduced number of data requests to obtain information from multiple sources. The augmented reality user device allows the user to process an image of the document to extract information from the document for the data request. Additionally, the augmented reality user device allows the user to authenticate themselves to obtain information that allows the user to request and obtain personal information that is specific to the user without having to provide different credentials to authenticate the user with each data source. The amount of processing resources used to generate the reduced number of requests is significantly less than the amount of processing resources used by existing systems. The overall performance of the system is improved as a result of consuming less processing resources. Using a reduced number of data requests to obtain information from multiple sources reduces the amount of data traffic required to obtain the information which results in improved network utilization and network performance.

Securely transferring data and information across a network poses several technical challenges. Networks are susceptible to attacks by unauthorized users trying to gain access to sensitive information being communicated across the network. Unauthorized access to a network may compromise the security of the data and information being communicated across the network.

One technical solution for improving network security is an augmented reality user device that generates and uses document tokens to allow a user to send information for requesting potentially sensitive information for a document. The augmented reality user device allows document tokens to be generated automatically upon identifying and extracting text information from a document. The document token may be encoded or encrypted to obfuscate the information being communicated by it. Using document tokens to mask information that is communicated across the network protects users and their information in the event of unauthorized access to the network and/or data occurs. The document tokens also allow for data transfers to be executed using less information than other existing systems, and thereby reduces the amount of data that is communicated across the network. Reducing the amount of data that is communicated across the network improves the performance of the network by reducing the amount of time network resource are occupied.

The augmented reality user device uses optical character recognition of text and images to quickly retrieve information for generating document tokens. The augmented reality user device allows information for generating document tokens to be retrieved based on an image of a document which significantly reduces the amount of time required to make a data request compared to existing systems that rely on the user to manually enter all of the information for the request. Using optical character recognition to identify and retrieve text information also allows the augmented reality user device to be less dependent on user input, which reduces the likelihood of user input errors and improves reliability of the system.

In addition to providing several technical solutions to these technical challenges, an augmented reality user device allows a user view information about a document as virtual or graphical object overlaid onto the physical document in real-time. For example, using the augmented reality user device, the user is able to quickly view information for multiple documents that are in front of the user. The user is able to view information about the document, their personal information, and/or their previous actions or history with the document as a virtual object overlaid onto the documents or any other tangible objects in the real scene.

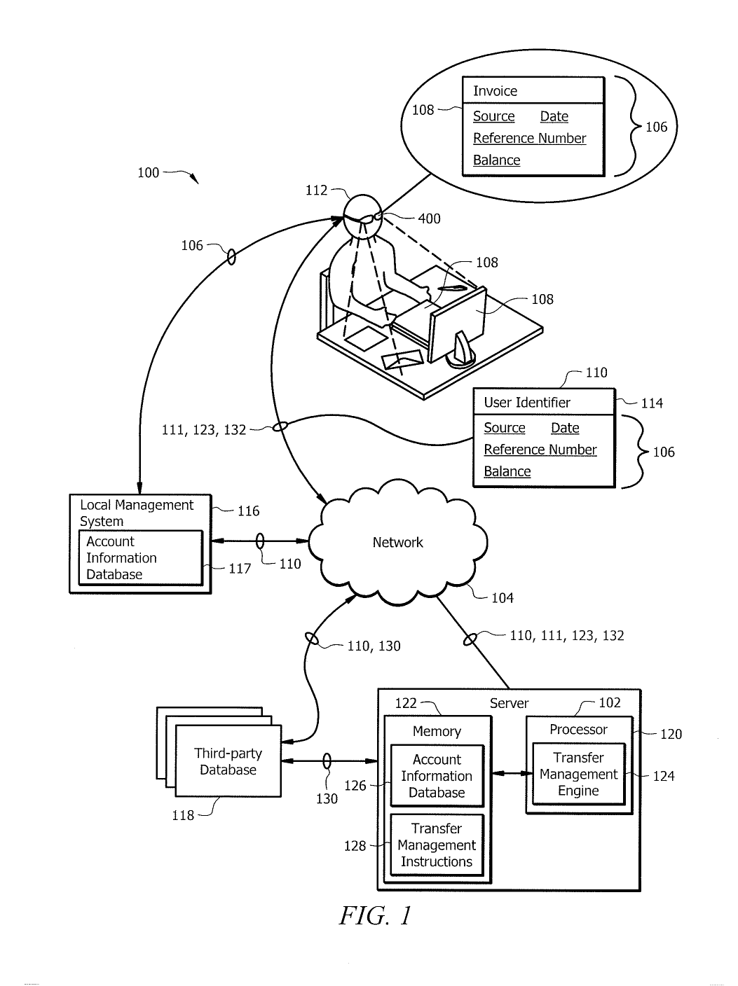

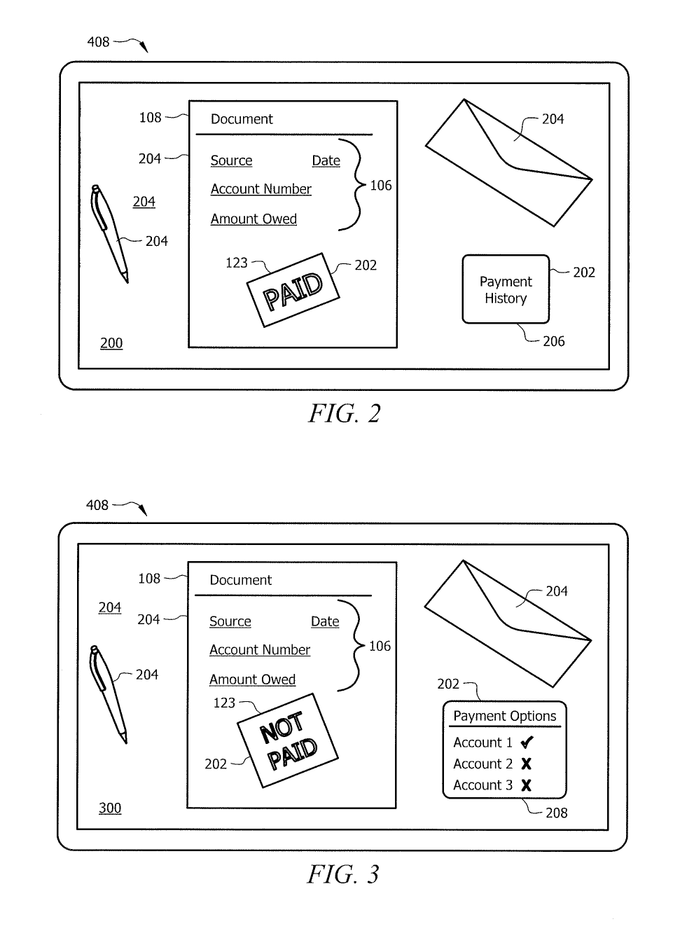

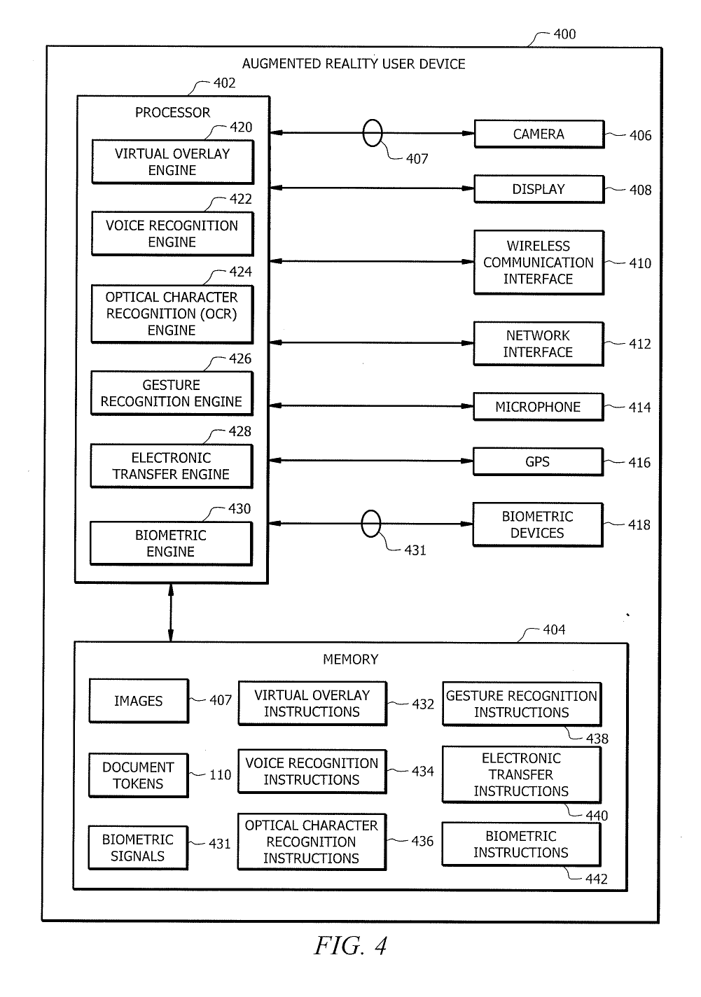

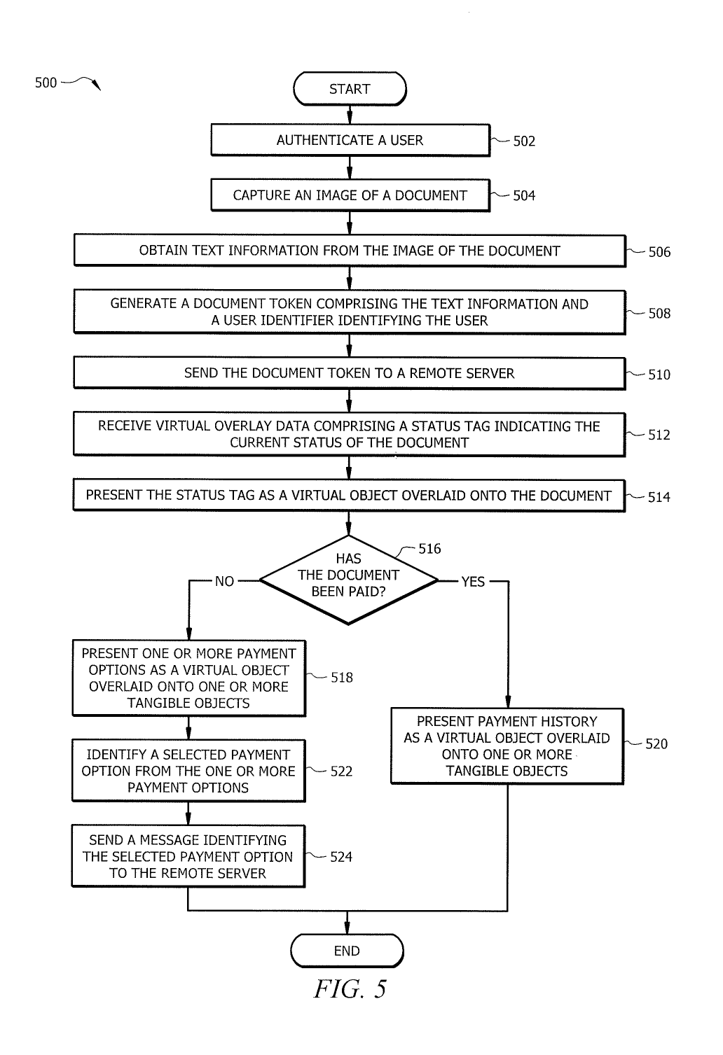

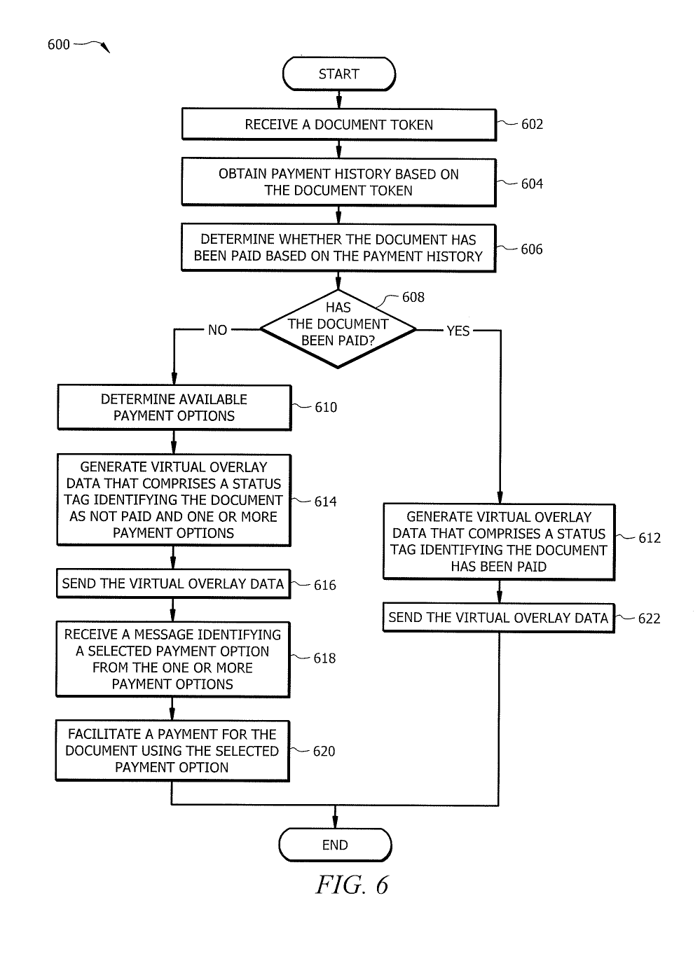

FIG. 1 illustrates a user employing an augmented reality user device to view virtual objects overlaid with physical documents that are in front of the user. FIGS. 2 and 3 provide first person views of what a user might see when using the augmented reality user device to view virtual objects overlaid with physical documents. FIG. 4 is an embodiment of how an augmented reality user device may be configured and implemented. FIGS. 5 and 6 are examples of a process for facilitating augmented reality overlays using an augmented reality user device and a server, respectively.

FIG. 1 is a schematic diagram of an embodiment of a augmented reality system 100 configured to overlay virtual objects with a real scene. The augmented reality system 100 comprises an augmented reality user device 400 in signal communication with a remote server 102 via a network 104. The augmented reality user device 400 is configured to employ any suitable connection to communicate data with the remote server 102. In FIG. 1, the augmented reality user device 400 is configured as a head-mounted wearable device. Other examples of wearable devices are integrated into a contact lens structure, an eye glass structure, a visor structure, a helmet structure, or any other suitable structure. In some embodiments, the augmented reality user device 400 may be or may be integrated with a mobile user device. Examples of mobile user devices include, but are not limited to, a mobile phone, a computer, a tablet computer, and a laptop computer. For example, the user 112 may use a smart phone as the augmented reality user device 400 to overlay virtual objects with a real scene. Additional details about the augmented reality user device 400 are described in FIG. 4.

Examples of an augmented reality user device 400 in operation are described below and in FIG. 5. The augmented reality user device 400 is configured to identify and authenticate a user 112 and to provide a user identifier 114 that identifies the user 112 for a document token 110. The user identifier 114 is a label or descriptor (e.g. a name based on alphanumeric characters) used to identify the user 112. The augmented reality user device 400 is configured to use one or more mechanisms such as credentials (e.g. a log-in and password) or biometric signals to identify and authenticate the user 112.

The augmented reality user device 400 is further configured to capture text information 106 from a document 108 and to generate a document token 110 comprising the text information 106 and the user identifier 114 that is used to request information linked with the document 108 and the user 112. In one embodiment, the document 108 is a physical document such as a paper document. In another embodiment, the document 108 is a physical representation of an electronic document, for example, an electronic document being displayed on a graphical user interface of a user device (e.g. a computer, a tablet, or a smart phone). Examples of documents include, but are not limited to, articles, newspapers, books, magazines, account information, statements, invoices, checks, shipping receipts, gift certificates, coupons, rebates, warranties, or any other type of document. The text information 106 may include a source name, a date, a reference number, account number, a balance, a summary, a description, a routing number, tracking number, a barcode number, a gift card number, product information, and/or any other suitable information, or combinations thereof.

The augmented reality user device 400 is further configured to receive virtual overlay data 111 comprising information related to the document 108 and to present the received information as a virtual object overlaid with the document 108. For example, the augmented reality user device 400 is configured to present one or more payment options available to the user 112 and to identify a selected payment option from the user 112 when the augmented reality user device 400 receives virtual overlay data 111 comprising one or more payment options. The augmented reality user device 400 receives the indication of the selected payment option from the user 112 as a voice command, a gesture, an interaction with a button on the augmented reality user device 400, or in any other suitable form. The augmented reality user device 400 is configured to send a message 132 identifying the selected payment option to the remote server 102 to initiate a payment associated with the document 108 (e.g. when the document 108 is an invoice or the like) using the selected payment option.

In one embodiment, the augmented reality user device 400 is configured to obtain payment information from the user 112 that is different than the one or more payment options presented to the user 112. For example, the user 112 may want to use a physical card (e.g. a gift card, credit card, or debit card) or physical check to make a payment. The augmented reality user device 400 is configured to use optical character recognition to obtain text information from the card or check and to use the text information as payment information. The augmented reality user device 400 is configured to send a message 132 comprising the payment information to the remote server 102 to initiate a payment of the document 108 using the provided payment information.

In one embodiment, the augmented reality user device 400 is also in signal communication with a local management system 116. The augmented reality user device 400 is in signal communication with the local management system 116 using a wired or wireless connections. Examples of wireless connections include, but are not limited to, a Bluetooth connection, a local area network (LAN) connection, a personal area network (PAN) connection, a wide area network (WAN) connection, a Wi-Fi connection, a ZigBee connection, or any other suitable connection.

The local management system 116 is a user device (e.g. a computer or mobile device) owned or managed by the user 112. The local management system 116 comprises management software and/or an account information database 117. In one embodiment, the account information database 117 comprises information including, but not limited to, transactions and payment history for the user 112. The local management system 116 is configured to receive text information 106 of a document 108 from the augmented reality user device 400 and to use the text information 106 to look-up information linked with the document 108 and the user 112 in the account information database 117. For example, the local management system 116 compares the text information 106 to records in the account information database 117 to locate payment history for the user 112 and/or the document 108. In one embodiment, the local management system 116 is configured to generate the document token 110 and to send the document token 110 to the remote server 102 when information linked with the document 108 and the user 112 is not found in the account information database 117, for example, when the local management system 116 is unable to locate payment history information for the user 112 and the document 108 or is unable determine whether the user 112 paid the document 108.

The network 104 comprises a plurality of network nodes configured to communicate data between the augmented reality user device 400 and one or more servers 102 and/or third-party databases 118. Examples of network nodes include, but are not limited to, routers, switches, modems, web clients, and web servers. The network 104 is configured to communicate data (e.g. document tokens 110 and virtual overlay data 111) between the augmented reality user device 400 and the server 102. Network 104 is any suitable type of wireless and/or wired network including, but not limited to, all or a portion of the Internet, the public switched telephone network, a cellular network, and a satellite network. The network 104 is configured to support any suitable communication protocols as would be appreciated by one of ordinary skill in the art upon viewing this disclosure.

The server 102 is linked to or associated with one or more institutions. Examples of institutions include, but are not limited to, organizations, businesses, government agencies, financial institutions, and universities, among other examples. The server 102 is a network device comprising one or more processors 120 operably coupled to a memory 122. The one or more processors 120 are implemented as one or more central processing unit (CPU) chips, logic units, cores (e.g. a multi-core processor), field-programmable gate array (FPGAs), application specific integrated circuits (ASICs), or digital signal processors (DSPs). The one or more processors 120 are communicatively coupled to and in signal communication with the memory 122.

The one or more processors 120 are configured to process data and may be implemented in hardware or software. The one or more processors 120 are configured to implement various instructions. For example, the one or more processors 120 are configured to implement a transfer management engine 124. In an embodiment, the transfer management engine 124 is implemented using logic units, FPGAs, ASICs, DSPs, or any other suitable hardware.

Examples of the transfer management engine 124 in operation are described in detail below and in FIG. 6. In one embodiment, the transfer management engine 124 is configured to receive document tokens 110 and to process document tokens 110 to identify a user identifier 114 for a user 112 and text information 106 from a document 108. In one embodiment, processing the document token 110 comprises decrypting and/or decoding the document token 110 when the document token 110 is encrypted or encoded by the augmented reality user device 400. The transfer management engine 124 employs any suitable decryption or decoding technique as would be appreciated by one of ordinary skill in the art. The transfer management engine 124 is configured to use the user identifier 114 for the user 112 to look-up and identify account information for the user 112 in an account information database 126. The transfer management engine 124 is further configured to use the text information 106 to determine the status of the document 108, for example, whether the document 108 has been paid. For example, the transfer management engine 124 is configured to first use the user identifier 114 to locate payment history for the user 112 and then uses the text information 106 to search the payment history for a transaction that corresponds with the text information 106. In this example, the transfer management engine 124 determines that the status of the document 108 as paid when a transaction is found for the document 108. The transfer management engine 124 determines the status of the document 108 as unpaid when a transaction is not found for the document 108.

The transfer management engine 124 is further configured to generate virtual overlay data 111 to send to the augmented reality user device 400 in response to receiving the document token 110. Virtual overlay data 111 comprises a status tag 123 that indicates the current status of a document 108. A status tag 123 may indicate the current status of a document 108 as active, inactive, pending, on hold, paid, unpaid, current, old, expired, deposited, not shipped, shipped, in transit, delivered, unredeemed, redeemed, a balance amount, or any other suitable status to described the current status of the document 108. In one embodiment, status tags 123 are metadata that is added to a document or file. In another embodiment, status tags 123 are separate files that are each linked with or reference a document 108 or file. Virtual overlay data 111 may further comprise payment options, payment scheduling information, account information, or any other suitable information related to the user 112 and/or the document 108.

The transfer management engine 124 is further configured to receive a message 132 from the augmented reality user device 400 that identifies a selected payment option from the user 112. For example, the selected payment option identifies a checking account, a savings account, a credit card, or any other payment account for the user 112. The transfer management engine 124 is configured to facilitate a payment of the document 108 on behalf of the user 112 using the selected payment option.

The transfer management engine 124 is further configured to send updated virtual overlay data 111 to the augmented reality user device 400 that comprises an updated status tag 123. For example, the transfer management engine 124 is configured to send virtual overlay data 111 with a status tag 123 that identifies the document 108 as paid when the transfer management engine 124 makes a payment on the document 108.

The memory 122 comprises one or more disks, tape drives, or solid-state drives, and may be used as an over-flow data storage device, to store programs when such programs are selected for execution, and to store instructions and data that are read during program execution. The memory 122 may be volatile or non-volatile and may comprise read-only memory (ROM), random-access memory (RAM), ternary content-addressable memory (TCAM), dynamic random-access memory (DRAM), and static random-access memory (SRAM). The memory 122 is operable to store an account information database 126, transfer management instructions 128, and/or any other data or instructions. The transfer management instructions 128 comprise any suitable set of instructions, logic, rules, or code operable to execute the transfer management engine 124. The account information database 126 comprises account information that includes, but is not limited to, institution names, account names, account balances, account types, and payment history. In an embodiment, the account information database 126 is stored in a memory external of the server 102. For example, the server 102 is operably coupled to a remote database storing the account information database 126.

In one embodiment, the server 102 is in signal communication with one or more third-party databases 118. Third-party databases 118 are databases owned or managed by a third-party source. Examples of third-party sources include, but are not limited to, vendors, institutions, and businesses. In one embodiment, the third-party databases 118 comprise account information and payment history for the user 112. In one embodiment, third-party databases 118 are configured to push (i.e. send) data to the server 102. The third-party database 118 is configured to send information (e.g. payment history information) for a user 112 to the server 102 with or without receiving a data request for the information. The third-party database 118 is configured to send the data periodically to the server 102, for example, hourly, daily, or weekly. For example, the third-party database 118 is associated with a vendor and is configured to push payment history information linked with the user 112 to the server 102 hourly. The payment history comprises transaction information linked with the user 112. In another example, the third-party database 118 is associated with a mail courier and is configured to push shipping information linked with user 112 to the server 102 daily. The shipping information comprises tracking information linked with the user 112.

In another embodiment, a third-party database 118 is configured to receive a data request 130 for information linked with a document 108 and/or the user 112 from the server 102 and to send the requested information back to the server 102. For example, a third-party database 118 is configured to receive a user identifier 114 for the user 112 in the data request 130 and uses the user identifier 114 to look-up payment history information for the user 112 within the records of the third-party database 118. In another example, a third-party database 118 is configured to receive text information 106 comprising a reference number in the data request 130 and to use the reference number to look-up payment history information for the user 112 within the records of the third-party database 118. In other examples, third-party databases 118 are configured to use any information provided to the server 102 to look-up information related to a document 108 and/or the user 112.

In one embodiment, the augmented reality user device 400 is configured to send a document token 110 or a data request 130 to the third-party database 118. In other words, the augmented reality user device 400 sends the document token 110 or data request 130 directly to the third-party database 118 for information linked with the document 108 and the user 112 instead of to the server 102. The third-party databases 118 are configured to receive a document token 110 or a data request 130 for information linked with a document 108 and/or the user 112 from the augmented reality user device 400 and to send the requested information back to the augmented reality user device 400.

The following is a non-limiting example of how the augmented reality system 100 may operate. In this example, a user 112 using the augmented reality user device 400 is reviewing documents 108 at their desk. The user 112 authenticates themselves before using the augmented reality user device 400 by providing credentials (e.g. a log-in and password) or a biometric signal. The augmented reality user device 400 authenticates the user based on the user's input and allows the user to generate and send document tokens 110. The augmented reality user device 400 identifies the user 112 and/or a user identifier 114 for the user 112 upon authenticating the user 112. Once the user 112 has been authenticated, the user identifier 114 is used by other systems and devices to identify and authenticate the user 112 without requiring the user 112 to provide additional credentials for each system.

Once the user 112 is authenticated, the user 112 looks at one of the documents 108 with the augmented reality user device 400. The augmented reality user device 400 performs optical character recognition to identify text information 106 on the document 108. As an example, the text information 106 identifies a source of the document 108, the date the document 108 was generated or sent, a reference number for the user 112, and a remaining balance. For instance, the document 108 may be for an auto loan for the user 112 and identifies the lender, the statement period, an account number, and the remaining balance on a loan. The user 112 is interested in determining whether or not this document has already been paid. The augmented reality user device 400 generates a document token 110 that comprises the text information 106 and the user identifier 114 and sends the document token 110 to the remote server 102. In one embodiment, the augmented reality user device 400 encrypts and/or encodes the document token 110 prior to sending the document token 110 to the remote server 102.

The server 102 receives the document token 110 and processes the document token 110 to identify the user identifier 114 for the user 112 and the text information 106 from the document 108. The server 102 decrypts or decodes the document token 110 when the document token 110 is encrypted or encoded by the augmented reality user device 400. The server 102 uses the user identifier 114 to look-up account information for the user 112 in the account information database 126. For example, the server 102 identifies a payment history and available payment options for the user 112 based on the user's 112 account information. The server 102 uses the text information 106 with the payment history for the user 112 to determine whether the user 112 has already paid the document 108. For instance, the server 102 searches the payment history for any transactions made by the user 112 that corresponds with the text information 106.

In one embodiment, the server 102 sends a data request to one or more third-party databases 118 to look for information linked with the document 108 or the user 112. For example, the server 102 sends a data request 130 to the business identified by the text information 106 as the source of the document 108 to request information. When the server 102 receives the information from the third-party database 118, the server 102 determines the status of the document 108 based on the received information. For example, the server 102 determines whether the user 112 has already paid the document 108 based on the received information.

The server 102 determines the current status of the document 108 and generates a status tag 123 for the document 108 based on the current status of the document 108. In one embodiment, the status tag 123 identifies the document 108 as paid when the server 102 determines that the user 112 has already paid the document 108. The status tag 123 identifies the document 108 as unpaid when the server 102 determines that the user 112 has not paid the document 108 yet.

The server 102 generates virtual overlay data 111 that comprises information associated with the status tag 123. The virtual overlay data 111 further comprises the one or more payment options that are available to the user 112 based on the user's 112 account information when the status tag 123 identifies the document 108 as unpaid. The one or more payment options each identify a payment account for the user 112. In some embodiments, the virtual overlay data 111 further comprises suggested payment dates for each of the payment options. The server 102 then sends the virtual overlay data 111 to the augmented reality user device 400.

The augmented reality user device 400 receives the virtual overlay data 111 and processes the virtual overlay data 111 to identify the status tag 123 for the document 108 and any other information. The augmented reality user device 400 presents the status tag 123 as a virtual object in an augmented reality display. In one embodiment, the augmented reality user device 400 presents the status tag 123 as a virtual object overlaid onto the document 108 in a real scene. In another embodiment, the augmented reality user device 400 presents the status tag 123 as a virtual object adjacent to the document 108 in the real scene. For example, the augmented reality user device 400 overlays a virtual object that identifies the document 108 as paid onto the document 108 when the status tag 123 identifies the document 108 as paid. The augmented reality user device 400 overlays a virtual object that identifies the document 108 as unpaid onto the document 108 when the status tag 123 identifies the document 108 as unpaid. The virtual objects being overlaid onto the document 108 allows the user 112 to readily see the status of the document 108.

The augmented reality user device 400 may also present other information such as payment history or payment options as virtual objects overlaid onto one or more tangible objects in the real scene. For example, the augmented reality user device 400 overlays a virtual object that comprises payment information linked with the user 112 and the document 108 onto one or more tangible objects in the real scene when the status tag 123 identifies the document 108 as paid. As another example, the augmented reality user device 400 overlays a virtual object that comprises the one or more payment options linked with the user 112 onto one or more tangible objects in the real scene when the status tag 123 identifies the document 108 as unpaid.

When the augmented reality user device 400 presents the one or more payment options, the augmented reality user device 400 identifies a selected payment option from the user 112. The augmented reality user device 400 receives the indication of the selected payment option from the user 112 as a voice command, a gesture, an interaction with a button on the augmented reality user device 400, or in any other suitable form. The augmented reality user device 400 is configured to send a message 132 identifying the selected payment option to the remote server 102.

The server 102 receives the message 132 identifying the selected payment option and facilitates a payment of the document 108 using the selected payment option for the user 112. For example, when the message 132 indicates the user's 112 checking account, the server 102 facilitates a payment of the document 108 using the user's 112 checking account. In one embodiment, the server 102 sends updated virtual overlay data 111 to the augmented reality user device 400 that comprises a status tag 123 identifying the document 108 as paid.

FIGS. 2 and 3 are examples of an augmented reality user device 400 presenting different virtual objects for a document 108. The virtual objects are based on text information 106 provided by the document 108 and account information for the user 112 viewing the document 108.

FIG. 2 is an embodiment of a first person view from a display 408 of an augmented reality user device 400 overlaying virtual objects 202 onto tangible objects 204 within a real scene 200. Examples of tangible objects 204 include, but are not limited to, documents, furniture, people, or any other physical objects. In FIG. 2, a user 112 is sitting at their desk using the augmented reality user device 400. The user 112 may have several documents on their desk and wants to review the status of different documents 108. The user 112 can determine the status of a document 108 by using the augmented reality user device 400 to view text information 106 on the document 108.

For example, the document 108 is an invoice from a vendor and the user 112 wants to determine whether they have already paid the invoice. The augmented reality user device 400 identifies text information 106 on the document 108 that indicates the vendor and other billing information. The augmented reality user device 400 generates a document token 110 for the document 108 based on the identified text information 106 and sends the document token 110 to a remote server 102. The document token 110 allows the user 112 to request information about the status of the document 108. The status of the document 108 may be determined based on information from multiple sources. For example, the status of the document 108 is based on account information for the user 112 which is stored in the server 102 and transaction information from the vendor which is stored in a third-party database 118 linked with the vendor. In other examples, information for determining the status of the document 108 may be located in any other sources and/or combinations of sources. The document token 110 allows the augmented reality user device 400 to make fewer data requests (e.g. a single data request) to obtain the status of the document 108 regardless of the number of sources used to compile the information for determining the status of the document 108. Using a reduced number of data requests improves the efficiency of the system compared to other systems that make individual requests to each source. Additionally, the augmented reality user device 400 is able to request the status of the document 108 without knowledge of which sources or how many sources need to be queried for information linked with the user 112 and the document 108.

In response to sending the document token 110 to the server 102, the augmented reality user device 400 receives a status tag 123 for the document 108. The status tag 123 indicates the current status of the document 108. The augmented reality user device 400 presents the status tag 123 for the document 108 as a virtual object 202 overlaid with the real scene in front of the user. The status tag 123 may be overlaid onto at least a portion of the document 108. In this example, the status tag 123 identifies the document 108 as paid. However, the status tag 123 could provide information identifying any suitable status of the document 108. The status tag 123 allows the user 112 to quickly determine the status of the document 108 and any other information linked with the document 108.

The augmented reality user device 400 also presents payment history 206 for the document 108 as a virtual object 202 overlaid onto one or more tangible objects 204. The payment history 206 may comprise information related to a transaction linked with the document 108. For example, the payment history may comprise a transaction timestamp, account information, a payment account used for the transaction, and/or any other information, or combinations thereof. In other examples, the augmented reality user device 400 presents any other information linked with the user 112 and/or the document 108.

FIG. 3 is another embodiment of a first person view from a display 408 of an augmented reality user device 400 overlaying virtual objects 202 onto tangible objects 204 within a real scene 300. Similar to FIG. 2, the user 112 is sitting at their desk using the augmented reality user device 400 and would like to determine the status of another document 108. The augmented reality user device 400 identifies text information 106 from the document 108, generates a document token 110, and sends the document token 110 to a server 102 similarly to as described in FIG. 2. The augmented reality user device 400 receives a status tag 123 for the document 108 in response to sending the document token 110.

In FIG. 3, the status tag 123 identifies the document 108 as not paid. In this example, the augmented reality user device 400 also presents payment options 208 for the document 108 as a virtual object 202 overlaid onto one or more tangible objects 204. The payment options 208 comprise one or more payment options that are available to the user based on their account information. In an embodiment, the payment options 208 comprise recommendations about which payment option 208 the user should use based on their account information. For example, the payment options 208 recommends the user should use the first account and not the second or third account.

In another example, the document 108 is a shipping receipt and the augmented reality user device 400 is used to determine the status of a package linked with the shipping receipt. The augmented reality user device 400 generates and sends a document token 110 based on text information 106 from the shipping receipt. For example, the text information 106 identifies a tracking number and a shipping courier. The augmented reality user device 400 receives a status tag 123 for the shipping receipt that indicates the status of the package linked with the shipping receipt. The status tag 123 is overlaid onto the shipping receipt. The status tag 123 indicates the package status as not yet shipped, shipped, in transit, delivered, or any other suitable status.

In another example, the document 108 is a coupon or a voucher and the augmented reality user device 400 is used to determine the status of the coupon. The augmented reality user device 400 generates and sends a document token 110 based on the text information 106 from the coupon. For example, the text information 106 identifies a barcode number. The augmented reality user device 400 receives a status tag 123 for the coupon that indicates the status of the coupon. The status tag 123 indicates the whether the coupon is unused, used, expired, or any other suitable status.

In another example, the document 108 is a check the user previously attempted to deposit, for example, at an automated teller machine (ATM) or using an application on a mobile device. The augmented reality user device 400 is used to determine the status of the check. The augmented reality user device 400 generates and sends a document token 110 based on text information 106 from the check. For example, the text information 106 identifies a check number, an account number, a routing number, and a check value. The augmented reality user device 400 receives a status tag 123 for the check that indicates the status of the check. The status tag 123 indicates the check status as pending, deposited, or any other suitable status.

In another example, the document 108 is a gift card and the augmented reality user device 400 is used to determine the status (e.g. the remaining balance) of the gift card. The augmented reality user device 400 generates and sends a document token 110 based on the text information 106 from the gift card. For example, the text information 106 identifies a gift card number. The augmented reality user device 400 receives a status tag 123 for the gift card that indicates the status of the gift card. The status tag 123 indicates the remaining balance, whether the gift card is expired, or any other suitable status.

FIG. 4 is a schematic diagram of an embodiment of an augmented reality user device 400 employed by the augmented reality system 100. The augmented reality user device 400 is configured to capture text information from a document 108, to send a document token 110 comprising the text information 106 from the document 108 to a remote server 102, to receive a status tag 123 for the document 108 in response to sending the document token 110, and to present the status tag 123 as a virtual object overlaid onto one or more tangible objects in a real scene. An example of the augmented reality user device 400 in operation is described in FIG. 5.

The augmented reality user device 400 comprises a processor 402, a memory 404, a camera 406, a display 408, a wireless communication interface 410, a network interface 412, a microphone 414, a global position system (GPS) sensor 416, and one or more biometric devices 418. The augmented reality user device 400 may be configured as shown or in any other suitable configuration. For example, augmented reality user device 400 may comprise one or more additional components and/or one or more shown components may be omitted.

Examples of the camera 406 include, but are not limited to, charge-coupled device (CCD) cameras and complementary metal-oxide semiconductor (CMOS) cameras. The camera 406 is configured to capture images 407 of people, text, and objects within a real environment. The camera 406 is configured to capture images 407 continuously, at predetermined intervals, or on-demand. For example, the camera 406 is configured to receive a command from a user to capture an image 407. In another example, the camera 406 is configured to continuously capture images 407 to form a video stream of images 407. The camera 406 is operable coupled to an optical character (OCR) recognition engine 424 and/or the gesture recognition engine 426 and provides images 407 to the OCR recognition engine 424 and/or the gesture recognition engine 426 for processing, for example, to identify gestures, text, and/or objects in front of the user.

The display 408 is configured to present visual information to a user in an augmented reality environment that overlays virtual or graphical objects onto tangible objects in a real scene in real-time. In an embodiment, the display 408 is a wearable optical head-mounted display configured to reflect projected images and allows a user to see through the display. For example, the display 408 may comprise display units, lens, semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active matric OLED (AMOLED), an organic LED (OLED) display, a projector display, or any other suitable type of display as would be appreciated by one of ordinary skill in the art upon viewing this disclosure. In another embodiment, the display 408 is a graphical display on a user device. For example, the graphical display may be the display of a tablet or smart phone configured to display an augmented reality environment with virtual or graphical objects overlaid onto tangible objects in a real scene in real-time. Examples of the wireless communication interface 410 include, but are not limited to, a Bluetooth interface, a radio frequency identifier (RFID) interface, a near-field communication (NFC) interface, a LAN interface, a PAN interface, a WAN interface, a Wi-Fi interface, a ZigBee interface, or any other suitable wireless communication interface as would be appreciated by one of ordinary skill in the art upon viewing this disclosure. The wireless communication interface 410 is configured to allow the processor 402 to communicate with other devices. For example, the wireless communication interface 410 is configured to allow the processor 402 to send and receive signals with other devices for the user (e.g. a mobile phone) and/or with devices for other people. The wireless communication interface 410 is configured to employ any suitable communication protocol.

The network interface 412 is configured to enable wired and/or wireless communications and to communicate data through a network, system, and/or domain. For example, the network interface 412 is configured for communication with a modem, a switch, a router, a bridge, a server, or a client. The processor 402 is configured to receive data using network interface 412 from a network or a remote source.

Microphone 414 is configured to capture audio signals (e.g. voice commands) from a user and/or other people near the user. The microphone 414 is configured to capture audio signals continuously, at predetermined intervals, or on-demand. The microphone 414 is operably coupled to the voice recognition engine 422 and provides captured audio signals to the voice recognition engine 422 for processing, for example, to identify a voice command from the user.

The GPS sensor 416 is configured to capture and to provide geographical location information. For example, the GPS sensor 416 is configured to provide the geographic location of a user employing the augmented reality user device 400. The GPS sensor 416 is configured to provide the geographic location information as a relative geographic location or an absolute geographic location. The GPS sensor 416 provides the geographic location information using geographic coordinates (i.e. longitude and latitude) or any other suitable coordinate system.

Examples of biometric devices 418 include, but are not limited to, retina scanners and finger print scanners. Biometric devices 418 are configured to capture information about a person's physical characteristics and to output a biometric signal 431 based on captured information. A biometric signal 431 is a signal that is uniquely linked to a person based on their physical characteristics. For example, a biometric device 418 may be configured to perform a retinal scan of the user's eye and to generate a biometric signal 431 for the user based on the retinal scan. As another example, a biometric device 418 is configured to perform a fingerprint scan of the user's finger and to generate a biometric signal 431 for the user based on the fingerprint scan. The biometric signal 431 is used by a biometric engine 430 to identify and/or authenticate a person.

The processor 402 is implemented as one or more CPU chips, logic units, cores (e.g. a multi-core processor), FPGAs, ASICs, or DSPs. The processor 402 is communicatively coupled to and in signal communication with the memory 404, the camera 406, the display 408, the wireless communication interface 410, the network interface 412, the microphone 414, the GPS sensor 416, and the biometric devices 418. The processor 402 is configured to receive and transmit electrical signals among one or more of the memory 404, the camera 406, the display 408, the wireless communication interface 410, the network interface 412, the microphone 414, the GPS sensor 416, and the biometric devices 418. The electrical signals are used to send and receive data (e.g. images and document tokens) and/or to control or communicate with other devices. For example, the processor 402 transmit electrical signals to operate the camera 406. The processor 402 may be operably coupled to one or more other devices (not shown).

The processor 402 is configured to process data and may be implemented in hardware or software. The processor 402 is configured to implement various instructions. For example, the processor 402 is configured to implement a virtual overlay engine 420, a voice recognition engine 422, an OCR recognition engine 424, a gesture recognition engine 426, an electronic transfer engine 428, and a biometric engine 430. In an embodiment, the virtual overlay engine 420, the voice recognition engine 422, the OCR recognition engine 424, the gesture recognition engine 426, the electronic transfer engine 428, and the biometric engine 430 are implemented using logic units, FPGAs, ASICs, DSPs, or any other suitable hardware.

The virtual overlay engine 420 is configured to overlay virtual objects onto tangible objects in a real scene using the display 408. For example, the display 408 may be head-mounted display that allows a user to simultaneously view tangible objects in a real scene and virtual objects. The virtual overlay engine 420 is configured to process data to be presented to a user as an augmented reality virtual object on the display 408. An example of overlay virtual objects onto tangible objects in a real scene is shown in FIGS. 2 and 3.

The voice recognition engine 422 is configured to capture and/or identify voice patterns using the microphone 414. For example, the voice recognition engine 422 is configured to capture a voice signal from a person and to compare the captured voice signal to known voice patterns or commands to identify the person and/or commands provided by the person. For instance, the voice recognition engine 422 is configured to receive a voice signal to authenticate a user and/or to identify a selected option or an action indicated by the user.

The OCR recognition engine 424 is configured to identify objects, object features, text, and/or logos using images 407 or video streams created from a series of images 407. In one embodiment, the OCR recognition engine 424 is configured to identify objects and/or text within an image 407 captured by the camera 406. In another embodiment, the OCR recognition engine 424 is configured to identify objects and/or text in about real-time on a video stream captured by the camera 406 when the camera 406 is configured to continuously capture images 407. The OCR recognition engine 424 employs any suitable technique for implementing object and/or text recognition as would be appreciated by one of ordinary skill in the art upon viewing this disclosure.

The gesture recognition engine 426 is configured to identify gestures performed by a user and/or other people. Examples of gestures include, but are not limited to, hand movements, hand positions, finger movements, head movements, and/or any other actions that provide a visual signal from a person. For example, gesture recognition engine 426 is configured to identify hand gestures provided by a user to indicate various commands such as a command to initiate a request for an augmented reality overlay for a document. The gesture recognition engine 426 employs any suitable technique for implementing gesture recognition as would be appreciated by one of ordinary skill in the art upon viewing this disclosure.

The electronic transfer engine 428 is configured to extract text info′ nation 106 from a document 108 and to initiate the process of obtaining information linked with the document 108 and a user from one or more remote sources (e.g. server 102 and/or third-party databases 118). For example, when a user looks at a document 108 with the augmented reality user device 400, the electronic transfer engine 428 is configured to identify and extract text information 106 and/or images from the document 108 based on an image 407 of the document 108.

The electronic transfer engine 428 is further configured to generate a document token 110 that comprises the text information 106 and identifies the user. The electronic transfer engine 428 is configured to encrypt and/or encode the document token 110. Encrypting and encoding the document token 110 obfuscates and mask information being communicated by the document token 110. Masking the information being communicated protects users and their information in the event of unauthorized access to the network and/or data occurs. The electronic transfer engine 428 employs any suitable encryption or encoding technique as would be appreciated by one of ordinary skill in the art.

The electronic transfer engine 428 is configured to send the document token 110 to a remote server 102 to as a data request to initiate the process of obtaining information linked with the document 108 and the user. The electronic transfer engine 428 is further configured to provide the information (e.g. virtual overlay data 111) received from the remote server 102 to the virtual overlay engine 420 to present the information as one or more virtual objects overlaid with the document 108 and/or other tangible objects in a real scene. An example of employing the electronic transfer engine 428 to request information related to a document 108 and presenting the information to a user is described in FIG. 5.

In an embodiment, the electronic transfer engine 428 is further configured to present one or more payment options that are linked with the user. The electronic transfer engine 428 is configured to identify a selected payment option and to send a message to the remote server 102 that identifies the selected payment option. The user may identify a selected payment option by giving a voice command, performing a gesture, interacting with a physical component (e.g. a button, knob, or slider) of the augmented reality user device 400, or any other suitable mechanism as would be appreciated by one of ordinary skill in the art. An example of employing the electronic transfer engine 428 to identify a selected payment option and to send a message to the remote server 102 that identifies the selected payment option is described in FIG. 5.

The biometric engine 430 is configured to identify a person based on a biometric signal 431 generated from the person's physical characteristics. The biometric engine 430 employs one or more biometric devices 418 to identify a user based on one or more biometric signals 431. For example, the biometric engine 430 receives a biometric signal 431 from the biometric device 418 in response to a retinal scan of the user's eye and/or a fingerprint scan of the user's finger. The biometric engine 430 compares biometric signals 431 from the biometric device 418 to previously stored biometric signals 431 for the user to authenticate the user. The biometric engine 430 authenticates the user when the biometric signals 431 from the biometric devices 418 substantially matches (e.g. is the same as) the previously stored biometric signals 431 for the user.

The memory 404 comprise one or more disks, tape drives, or solid-state drives, and may be used as an over-flow data storage device, to store programs when such programs are selected for execution, and to store instructions and data that are read during program execution. The memory 404 may be volatile or non-volatile and may comprise ROM, RAM, TCAM, DRAM, and SRAM. The memory 404 is operable to store images, document tokens, virtual overlay instructions 432, voice recognition instructions 434, OCR recognition instructions 436, gesture recognition instructions 438, electronic transfer instructions 440, biometric instructions 442, and any other data or instructions.

Images 407 comprises images captured by the camera 406 and images 407 from other sources. In one embodiment, images 407 comprises images used by the augmented reality user device 400 when performing optical character recognition. Images 407 can be captured using camera 406 or downloaded from another source such as a flash memory device or a remote server via an Internet connection.

Biometric signals 431 are signals or data that is generated by a biometric device 418 based on a person's physical characteristics. Biometric signals 431 are used by the augmented reality user device 400 to identify and/or authenticate an augmented reality user device 400 user by comparing biometric signals 431 captured by the biometric devices 418 with previously stored biometric signals 431.

Document tokens 110 are generated by the electronic transfer engine 428 and sent to a remote server 102 to initiate a process for obtaining information linked with a document 108 and the user. In one embodiment, the document tokens 110 is a message or data request comprising any suitable information for requesting information from the remote server 102 and/or one or more other sources (e.g. third-party databases 118). For example, the document token 110 may comprise information identifying a user and text information 106 from a document 108. For instance, the text information 106 may comprise the name of the source of the document 108, a date, an account number, a balance, and/or any other information. An example of the augmented reality user device 400 generating and sending a document token 110 to initiate a process for obtaining information linked with a document 108 is described in FIG. 5.

The virtual overlay instructions 432, the voice recognition instructions 434, the OCR recognition instructions 436, the gesture recognition instructions 438, the electronic transfer instructions 440, and the biometric instructions 442 each comprise any suitable set of instructions, logic, rules, or code operable to execute the virtual overlay engine 420, the voice recognition engine 422, the OCR recognition engine 424, the gesture recognition engine 426, the electronic transfer engine 428, and the biometric engine 430, respectively.

FIG. 5 is a flowchart of an embodiment of an augmented reality overlaying method 500. Method 500 is employed by the processor 402 of the augmented reality user device 400 to generate a document token 110 based on a user of the augmented reality user device 400 and text information 106 from a document 108 which is used to request information related to the document 108 and the user. The augmented reality user device 400 presents the received information linked with the document 108 as a virtual object overlaid with the document 108.

At step 502, the augmented reality user device 400 authenticates the user. The user authenticates themselves by providing credentials (e.g. a log-in and password) or a biometric signal. The augmented reality user device 400 authenticates the user based on the user's input. The augmented reality user device 400 identifies the user and a user identifier 114 for the user. The user is able to generate and send document tokens 110 using the augmented reality user device 400 upon authenticating the user. The user identifier 114 may be used to identify and authenticate the user in other systems. At step 504, augmented reality user device 400 captures an image 407 of a document 108. In one embodiment, augmented reality user device 400 sends a command or signal that triggers the camera 406 to capture an image 407 of the document 108. In another embodiment, the camera 406 continuously or periodically captures images 407.

At step 506, the augmented reality user device 400 obtains text information 106 from the image 407 of the document 108. The augmented reality user device 400 performs optical character recognition on the image 407 to identify and extract text information 106 from the document 108. In one embodiment, the text information 106 identifies a source of the document 108, the date the document 108 was generated or sent, a reference number for the user, and a remaining balance. In other embodiments, the text information comprises any other information or combination of information.

At step 508, the augmented reality user device 400 generates a document token 110 comprising the text information 106 and the user identifier 114 that identifies the user. The document token 110 comprises the user identifier 114 and all or a portion of the text information 106 extracted from the document 108. The document token 110 comprises any suitable information from the document 108 and/or information for identifying the user. In one embodiment, the augmented reality user device 400 encrypts and/or encodes the document token 110 prior to sending the document token 110. Encrypting and/or encoding the document token 110 protects the user 112 and their information in the event of unauthorized access to the network and/or data occurs. At step 510, the augmented reality user device 400 sends the document token 110 to a remote server 102 for processing.

The document token 110 is used to request information about the status of the document 108. The status of the document 108 may be determined based on information from a variety of sources. The document token 110 allows the augmented user device 400 to send a fewer data requests for the status of the document 108 regardless of the number of sources containing the information for determining the status of the document 108. Using fewer data requests reduces the amount of data being sent and reduces the time that network resources are occupied compared to other systems that use multiple requests by sending individual requests to each source. The augmented reality user device 400 is able to request the status of the document 108 without knowledge of which sources or how many sources need to be queried for information linked with the user 112 and the document 108.

At step 512, the augmented reality user device 400 receives virtual overlay data 111 comprising a status tag 123 that indicates the current status of the document 108. The status tag 123 may indicate the current status of a document 108 as active, inactive, pending, on hold, paid, unpaid, current, old, expired, deposited, not shipped, shipped, in transit, delivered, unredeemed, redeemed, a balance amount, or any other suitable status to described the current status of the document 108. The status tag 123 identifies the document 108 as paid when the server 102 determines that the user has already paid the document 108. The status tag 123 identifies the document 108 as unpaid when the server 102 determines that the user has not paid the document 108 yet.

At step 514, the augmented reality user device 400 presents the status tag 123 as a virtual object overlaid onto the document 108. The augmented reality user device 400 presents the status tag 123 as a virtual object either overlaid on top of the document 108 or adjacent to the document 108. When the augmented reality user device 400 presents the status tag 123, the user can readily see the current status of the document 108 and determine if any further actions need to be taken.

At step 516, the augmented reality user device 400 determines whether the document 108 has been paid. In one embodiment, the augmented reality user device 400 determines whether the document 108 has been paid based on the status tag 123 of the document 108. For example, the augmented reality user device 400 determines the document 108 has been paid when the status tag 123 identifies the document 108 as paid. The augmented reality user device 400 determines that the document 108 is unpaid when the status tag 123 identifies the document 108 as not paid. In another embodiment, the augmented reality user device 400 determines the document 108 is paid based on the presence of payment history in the virtual overlay data 11. The augmented reality user device 400 also determines the document 108 is unpaid when the virtual overlay data 111 comprise one or more payment options for the user. In other embodiments, the augmented reality user device 400 may employ any other suitable technique for determining whether the document 108 has been paid. The augmented reality user device 400 proceeds to step 518 when the augmented reality user device 400 determines that the document 108 has been paid. Otherwise, the augmented reality user device 400 proceeds to step 520 when the augmented reality user device 400 determines that the document 108 has not been paid.

At step 518, the augmented reality user device 400 presents one or more payment options (e.g. payment options 208 shown in FIG. 3) as a virtual object overlaid onto one or more tangible objects. The augmented reality user device 400 presents the payment options as a virtual object either overlaid on top of the document 108 or adjacent to the document 108. For example, the one or more payment options may be overlaid onto one or more other tangible objects in the real scene with the document 108. The one or more payment options identify different payment accounts that are available to the user based on their account information. For example, the one or more payment accounts identifies a checking account, a savings account, a credit card, or any other payment account for the user.

At step 522, the augmented reality user device 400 identifies a selected payment option from the one or more payment options. The augmented reality user device 400 may receive the indication of the selected payment option from the user as a voice command, a gesture, an interaction with a button on the augmented reality user device 400, or in any other suitable form. For example, the user performs a hand gesture to select a payment option and the augmented reality user device 400 identifies the gesture and selected payment option using gesture recognition. In another example, the user gives a voice command to select the payment option and the augmented reality user device 400 identifies the voice command and the selected payment option using voice recognition. At step 524, the augmented reality user device 400 sends a message 132 identifying the selected payment option to the remote server 102.

Returning to step 516, the augmented reality user device 400 proceeds to step 520 when the augmented reality user device 400 determines that the document 108 has been paid. At step 520, the augmented reality user device 400 presents payment history for the document 108 as a virtual object overlaid onto one or more tangible objects or adjacent to the document 108. For example, the one or more payment options may be overlaid onto one or more other tangible objects in the real scene with the document 108. In an embodiment, step 520 may be optional and may be omitted.

FIG. 6 is a flowchart of another embodiment of an augmented reality overlaying method 600. Method 600 is employed by the transfer management engine 124 in the server 102 to determine the status of a document 108 and to provide information linked with the document 108 and a user of an augmented reality user device 400 in response to receiving a document token 110 for the document 108 from the augmented reality user device 400.

At step 602, the transfer management engine 124 receives a document token 110 from an augmented reality user device 400. In one embodiment, the transfer management engine 124 decrypts and/or decodes the document token 110 when the document token 110 is encrypted or encoded by the augmented reality user device 400. The transfer management engine 124 processes the document token 124 to identify a user identifier 114 identifying the user of the augmented reality user device 400. The transfer management engine 124 also processes the document token 124 to identify text information 106 for a document 108. In one embodiment, the text information 106 identifies a source of the document 108, the date the document 108 was generated or sent, a reference number for the user, and a remaining balance. In other embodiments, the text information comprises any other information or combination of information.

At step 604, the transfer management engine 124 obtains payment history for the user based on the document token 124. The transfer management engine 124 uses the user identifier 114 to look-up account information for the user 112 in the account information database 126.

At step 606, the transfer management engine 124 determines whether the document 108 has been paid based on the payment history. For example, the transfer management engine 124 searches the payment history for any transactions made by the user that corresponds with the text information 106. The transfer management engine 124 determines the status of the document 108 is paid when a transaction is found that for the document 108. The transfer management engine 124 determines the status of the document 108 as unpaid when a transaction is not found for the document 108.

At step 608, the transfer management engine 124 proceeds to step 610 to provide payment options that are available to the user when the transfer management engine 124 determines that the document 108 has not been paid. Otherwise, the transfer management engine 124 proceeds to step 612 to provide payment history information to the user when the transfer management engine 124 determines that the document 108 has been paid.

At step 610, the transfer management engine 124 determines available payment options for the user based on the user's account information. The transfer management engine 124 uses the user identifier 114 to look-up available payment options for the user 112 based on their account information in the account information database 126.

At step 614, the transfer management engine 124 generates virtual overlay data 111 that comprises a status tag 123 identifying the document 108 as not paid and the one or more payment options available for the user. In one embodiment, the transfer management engine 124 generates the status tag 123 as metadata that is combined with the document 108. In another embodiment, the status tag 123 is separate file that links to or references the document 108.

In one embodiment, the transfer management engine 124 may also make recommendations for the user such as suggested payment options to use and/or suggested dates for making a payment. These recommendations are based on the user's account information and are intended to help the user decide when and how to make a payment when the document 108 has not yet been paid. At step 616, the transfer management engine 124 sends the virtual overlay data 111 to the augmented reality user device 400.

At step 618, the transfer management engine 124 receives a message 132 that identifies a selected payment option from the one or more payment options for the user. For example, the selected payment option identifies a checking account, a savings account, a credit card, or any other payment account for the user.

At step 620, the transfer management engine 124 facilitates a payment for the document 108 using the selected payment option. For example, the transfer management engine 124 uses text information 106 from the document 108 to make a payment to the source of the document for the balance indicated by the document 108 using the selected payment option for the user.

Returning to step 608, the transfer management engine 124 proceeds to step 612 when the transfer management engine 124 determines that the document 108 has been paid. At step 612, the transfer management engine 124 generates virtual overlay data 111 that comprises a status tag 123 identifying the document 108 as paid. In one embodiment, the transfer management engine 124 may also provide payment history information for the user. The payment history information comprises information related to a payment of the document 108 such as a transaction date. At step 622, the transfer management engine 124 sends the virtual overlay data 111 to the augmented reality user device 400.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An augmented reality system comprising:
an augmented reality user device for a user comprising:
a display configured to overlay virtual objects onto tangible objects in real-time;
a camera configured to capture an image of a physical document;
one or more processors operably coupled to the display and the camera, and configured to implement:
an optical character recognition (OCR) engine configured to obtain text information from the image of the physical document;
an electronic transfer engine configured to:
generate a document token comprising the text information and a user identifier identifying the user;
encrypt the document token;
send the document token to a remote server;
receive virtual overlay data comprising a status tag indicating the current status of the physical document in response to sending the document token; and
a virtual overlay engine configured to present the status tag as a virtual object overlaid onto the physical document; and
a remote server comprising a transfer management engine configured to:
receive the document token;
decrypt the document token;
obtain payment history for the user based on the document token;
determine whether the physical document has been paid based on the payment history;
generate virtual overlay data that comprises the status tag identifying the physical document as paid in response to determining that the physical document has been paid;
generate virtual overlay data that comprises the status tag identifying the physical document as not paid in response to determining that the physical document has not been paid; and
send the virtual overlay data to the augmented reality user device.

2. The system of claim 1, wherein:
the virtual overlay data comprises one or more payment options when the status tag identifies the physical document as not paid;
the virtual overlay engine is configured to present the one or more payment options as a virtual object overlaid onto one or more tangible objects; and
the electronic transfer engine is configured to:
identify a selected payment option from the one or more payment option; and
send a message identifying the selected payment option to the remote server.

3. The system of claim 1, wherein:
the OCR engine is configured to obtain payment information from the user when the status tag identifies the physical document as not paid; and
the electronic transfer engine is configured to send the payment information to the remote server.

4. The system of claim 1, wherein:
the virtual overlay data comprise one or more payment options when the status tag identifies the physical document as not paid;
the payment options indicate:
a plurality of payment accounts; and
a suggested payment date for each of the plurality of payment accounts; and
the virtual overlay engine is configured to present the one or more payment options as a virtual object overlaid onto a tangible object.

5. The system of claim 1, wherein:
the virtual overlay data comprises payment history information; and
the virtual overlay engine is configured to present the payment history information as a virtual object overlaid onto one or more tangible objects when the status tag identifies the physical document as paid.

6. The system of claim 1, wherein:
the text information comprises a reference number; and
obtaining the payment history for the user comprises requesting the payment history from a third-party database based the reference number.

7. The system of claim 1, wherein:
the electronic transfer engine is configured to compare the text information to records in a local management system to determine whether the physical document has been paid; and
the document token is generated when the electronic transfer engine is unable to determine whether the physical document has been paid using the local management system.

8. An augmented reality overlaying method comprising:
capturing, using a camera on an augmented reality user device for a user, an image of a physical object;
obtaining, by an optical character recognition (OCR) engine, text information from the image of the physical document;
generating, by an electronic transfer engine, a document token comprising the text information and a user identifier identifying the user;
encrypting, by the electronic transfer engine, the document token;
sending, by the electronic transfer engine, the document token to a remote server;
receiving, by a transfer management engine of the remote server, the document token;
decrypting, by the transfer management engine, the document token;
obtaining, by the transfer management engine, payment history for the user based on the document token;
determining, by the transfer management engine, whether the physical document has been paid based on the payment history;
generating, by the transfer management engine, virtual overlay data that comprises a status tag identifying the physical document as paid in response to determining that the physical document has been paid;
generating, by the transfer management engine, virtual overlay data that comprises the status tag identifying the physical document as not paid in response to determining that the physical document has not been paid;
sending, by the transfer management engine, the virtual overlay data to the augmented reality user device
receiving, by the electronic transfer engine, virtual overlay data comprising the status tag indicating the current status of the physical document in response to sending the document token; and
presenting, by a virtual overlay engine, the status tag as a virtual object overlaid onto the physical document.

9. The method of claim 8, wherein the virtual overlay data comprises one or more payment options when the status tag identifies the physical document as not paid; and
further comprising:
presenting, by the virtual overlay engine, the one or more payment options as a virtual object overlaid onto one or more tangible objects;
identifying, by the electronic transfer engine, a selected payment option from the one or more payment option; and
sending, by the electronic transfer engine, a message identifying the selected payment option to the remote server.

10. The method of claim 8, further comprising:
obtaining, by the OCR engine, payment information from the user when the status tag identifies the physical document as not paid; and
sending, by the electronic transfer engine, the payment information to the remote server.

11. The method of claim 8, wherein:
the virtual overlay data comprise one or more payment options when the status tag identifies the physical document as not paid;
the payment options indicate:
a plurality of payment accounts; and
a suggested payment date for each of the plurality of payment accounts; and
further comprising presenting, by the virtual overlay engine, the one or more payment options as a virtual object overlaid onto a tangible object.

12. The method of claim 8, wherein the virtual overlay data comprises payment history information; and
further comprising presenting, by the virtual overlay engine, the payment history information as a virtual object overlaid onto one or more tangible objects when the status tag identifies the physical document as paid.

13. The method of claim 8, wherein:
the text information comprises a reference number; and
obtaining the payment history for the user comprises requesting the payment history from a third-party database based the reference number.

14. The method of claim 8, wherein:
the electronic transfer engine is configured to compare the text information to records in a local management system to determine whether the physical document has been paid; and
the document token is generated when the electronic transfer engine is unable to determine whether the physical document has been paid using the local management system.

15. An augmented reality user device comprising:
a display configured to overlay virtual objects onto tangible objects in real-time;
a camera configured to capture an image of a physical document;
one or more processors operably coupled to the display and the camera, and configured to implement:
an optical character recognition (OCR) engine configured to obtain text information from the image of the physical document;
an electronic transfer engine configured to:
generate a document token comprising the text information and a user identifier identifying the user;
encrypt the document token;
send the document token to a remote server;
receive virtual overlay data comprising a status tag indicating the current status of the physical document in response to sending the document token; and
a virtual overlay engine configured to present the status tag as a virtual object overlaid onto the physical document.

16. The apparatus of claim 15, wherein:
the virtual overlay data comprises one or more payment options when the status tag identifies the physical document as not paid;
the virtual overlay engine is configured to present the one or more payment options as a virtual object overlaid onto one or more tangible objects; and
the electronic transfer engine is configured to:
identify a selected payment option from the one or more payment option; and
send a message identifying the selected payment option to the remote server.

17. The apparatus of claim 15, wherein:
the OCR engine is configured to obtain payment information from the user when the status tag identifies the physical document as not paid; and
the electronic transfer engine is configured to send the payment information to the remote server.

18. The apparatus of claim 15, wherein:
the virtual overlay data comprise one or more payment options when the status tag identifies the physical document as not paid;
the payment options indicate:
a plurality of payment accounts; and
a suggested payment date for each of the plurality of payment accounts; and
the virtual overlay engine is configured to present the one or more payment options as a virtual object overlaid onto a tangible object.

19. The apparatus of claim 15, wherein:
the virtual overlay data comprises payment history information; and
the virtual overlay engine is configured to present the payment history information as a virtual object overlaid onto one or more tangible objects when the status tag identifies the physical document as paid.

20. The apparatus of claim 15, wherein the text information comprises a reference number used to obtain payment history for the user from a third-party database.
